(19) United States
(12) Patent Application Publication
(10) Pub. No.: US 2016/0334494 A1
(43) Pub. Date: Nov. 17, 2016

(54) BEACON SIGNAL RECEPTION SYSTEM, STORAGE DEVICE, TERMINAL DEVICE, AND BEACON SIGNAL RECEPTION METHOD

(71) Applicant: APLIX IP HOLDINGS CORPORATION, Tokyo (JP)

(72) Inventor: Masakazu Yamauchi, Tokyo (JP)

(73) Assignee: APLIX IP HOLDINGS CORPORATION, Tokyo (JP)

(21) Appl. No.: 15/222,723

(22) Filed: Jul. 28, 2016

Related U.S. Application Data
(63) Continuation of application No. PCT/JP2014/084377, filed on Dec. 25, 2014.

(30) Foreign Application Priority Data
Jan. 31, 2014 (JP) 2014-016548

(51) Int. Cl. G01S 5/02; G01S 5/00

(52) U.S. Cl. CPC G01S 5/0221; G01S 5/0263; G01S 5/0036

(57) ABSTRACT

A positioning unit of a terminal device measures the current position and outputs current position information. A beacon signal receiver of the terminal device receives a beacon signal and acquires a beacon ID of a beacon device included in the beacon signal. A processing unit of the terminal device refers to a beacon position database so as to acquire a beacon ID associated with the current position information, and sets the beacon ID to be acquired by the beacon signal receiver in accordance with the acquired beacon ID.

### TECHNICAL FIELD

The present invention relates, for example, to a beacon signal reception system for receiving a beacon signal, to a storage device, to a terminal device, and to a beacon signal reception method.

### BACKGROUND ART

In recent years, a beacon device has been provided that is installed, for example, at a supermarket, a convenience store, a department store and a specialty store, and is capable of transmitting a beacon signal to a terminal device carried by a user. Upon receipt of the beacon signal from the beacon device, the terminal device can acquire product information from the beacon signal by using an application installed on the terminal device, and display the product information on a display unit of the terminal device.

A known technology for enabling the beacon device to transmit the beacon signal and the terminal device to receive the beacon signal as described above is disclosed, for instance, in Patent Literature 1.

A data communication system proposed in Patent Literature 1 permits a seller device to detect, by using a beacon signal, that a purchaser device carried by a purchaser is in proximity to a seller store, and initiates communication between the seller device and the purchaser device so as to advertise products to the purchaser device, for example.

### CITATION LIST

### Patent Literature

PTL 1: Japanese Unexamined Patent Application Publication No. 2000-134147

### SUMMARY OF INVENTION

### Technical Problem

Meanwhile, when beacon devices are widely used to thereby increase the number of installed beacon devices, an application for receiving beacon signals from more beacon devices makes an appearance. For example, it is conceivable that a terminal device carried by a user is provided with an application that causes the terminal device to receive a beacon signal and acquire necessary information (for example, coupon information) from the beacon signal when the user visits a specific store at which a beacon device is installed. Here, it is assumed that a beacon ID is appended to the beacon signal as an example of identification information for uniquely identifying the beacon device.

However, when beacon signals are to be received from more beacon devices, various beacon IDs are appended to transmitted beacon signals. It takes a considerable amount of time for the terminal device to scan beacon IDs in order to determine a store equipped with a beacon device that has transmitted a beacon signal received by the terminal device. Thus, there is a problem in which it takes a significant amount of time for the user to acquire necessary information from the beacon signal received by the terminal device.

The present invention has been made in view of the above circumstances. An object of the present invention is to limit beacon devices of which signals are to be received in an environment where many beacon devices are installed.

### Solution to Problem

The present invention includes a terminal device capable of communicating with a server and accessing a database adapted to memorize, in association with each other, identification information, which identifies a beacon device that transmits a beacon signal, and position information, which indicates the installation position of the beacon device. In the terminal device, a server communication unit is capable of communicating with the server and accessing the database, and a positioning unit measures the current position and outputs current position information. A beacon signal receiver receives the beacon signal and acquires identification information of the beacon device, which is included in the beacon signal. A processing unit refers to the database to acquire the identification information associated with the current position information and sets, in accordance with the acquired identification information, the identification information to be acquired by the beacon signal receiver.

Further, the present invention is a terminal device including a storage unit that stores a database adapted to memorize, in association with each other, identification information, which identifies a beacon device that transmits a beacon signal, and position information, which indicates the installation position of the beacon device. In the terminal device, a positioning unit measures the current position and outputs current position information. A beacon signal receiver receives the beacon signal and acquires identification information of the beacon device, which is included in the beacon signal. A processing unit refers to the database to acquire the identification information associated with the current position information and sets, in accordance with the acquired identification information, the identification information to be acquired by the beacon signal receiver.

### Advantageous Effect of Invention

The present invention makes it possible to limit beacon devices of which signals are to be received by a terminal device and reduce the time required for identification information scanning.

### BRIEF DESCRIPTION OF DRAWINGS

FIG. 1 is a block diagram illustrating an exemplary configuration of a beacon signal reception system according to a first embodiment of the present invention.

FIG. 2 is a plan view illustrating an exemplary installation of a plurality of beacon devices according to the first embodiment of the present invention.

FIG. 3 is a diagram illustrating an exemplary data configuration of a beacon position database including absolute position information according to the first embodiment of the present invention.

FIG. 4 is a diagram illustrating an exemplary data configuration of the beacon position database including relative position information according to the first embodiment of the present invention.

FIG. 5 is a plan view illustrating an example in which an illegal beacon signal is blocked by a terminal device according to the first embodiment of the present invention.

FIG. 6 is a block diagram illustrating an exemplary configuration of the beacon signal reception system according to a first modification of the first embodiment of the present invention.

FIG. 7 is a diagram illustrating an exemplary data configuration of the beacon position database including absolute position information according to a second modification of the first embodiment of the present invention.

FIG. 8 is a diagram illustrating an exemplary data configuration of the beacon position database including relative position information according to the second modification of the first embodiment of the present invention.

FIG. 9 is a plan view illustrating an exemplary installation of a plurality of beacon devices according to a second embodiment of the present invention.

FIG. 10 is a diagram illustrating an exemplary data configuration of the beacon position database including absolute position information according to the second embodiment of the present invention.

FIG. 11 is a plan view illustrating an exemplary installation of a plurality of beacon devices according to a third embodiment of the present invention.

FIG. 12 is a diagram illustrating an exemplary data configuration of the beacon position database including absolute position information according to the third embodiment of the present invention.

FIG. 13 is a block diagram illustrating an exemplary configuration of the beacon signal reception system according to a fourth embodiment of the present invention.

FIG. 14 is a block diagram illustrating an exemplary configuration of the beacon signal reception system according to a fifth embodiment of the present invention.

### DESCRIPTION OF EMBODIMENTS

### 1-1. First Embodiment

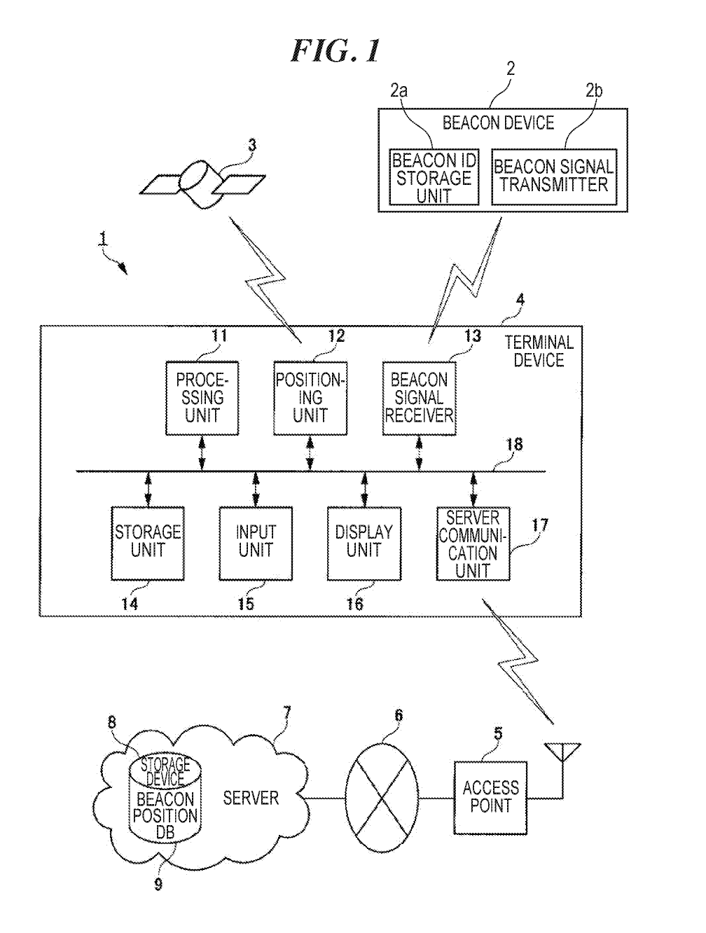

A beacon signal reception system according to a first embodiment of the present invention (an example in which a terminal device refers to a beacon position database of a server and provides current position information) will now be described with reference to FIGS. 1 to 5. When a computer executes a program in the beacon signal reception system, later-described functional blocks coordinate with each other so that the current position information can be provided based on installation position information of a beacon device, which is provided from the beacon device to the terminal device. In this document and in the accompanying drawings, elements having substantially the same function or configuration are designated by the same reference signs and will not be redundantly described. The “beacon position database” is hereinafter abbreviated to the “beacon position DB”.

<Exemplary Configuration of Beacon Signal Reception System>

FIG. 1 illustrates an exemplary configuration of the beacon signal reception system 1.

The beacon signal reception system 1 includes at least a terminal device 4 and a server 7. The terminal device 4 and the server 7 are capable of communicating with each other through an access point 5 and a network 6. In the following description, the “access point” is used as a term that includes a base station for mobile communication such as mobile phone communication, a communication interface for Wi-Fi (registered trademark) communication and the like.

The beacon signal reception system 1 also includes a beacon device 2 and a GPS satellite 3. The terminal device 4 acquires a current position by receiving a beacon signal transmitted from the beacon device 2 and a GPS signal transmitted from the GPS satellite 3.

The beacon device 2 includes a beacon ID storage unit 2a. The beacon ID storage unit 2a stores a beacon ID as an example of identification information assigned to identify the beacon device 2. The beacon device 2 also includes a beacon signal transmitter 2b. The beacon signal transmitter 2b transmits the beacon signal indicative of the beacon ID read from the beacon ID storage unit 2a.

As the beacon ID storage unit 2a, a nonvolatile memory, which does not lose data even when power is shut off, is used. However, a volatile memory can be used if power is continuously supplied to it.

The beacon signal transmitter 2b cyclically transmits the beacon signal to an area around the beacon device 2. Bluetooth (registered trademark), BLE (Bluetooth Low Energy), and other short-range wireless communication standards are suitable as the standard of communication between the beacon signal transmitter 2b and a beacon signal receiver 13 included in the terminal device 4. For example, the beacon device 2 compliant with the BLE standard is capable of permitting the beacon signal transmitter 2b to broadcast advertising data including the beacon ID, as the beacon signal, to an area around the beacon device 2.

The GPS satellite 3 is transmitting the GPS signal toward the ground surface from a satellite orbit.

The terminal device 4 includes a processing unit 11, a positioning unit 12, a beacon signal receiver 13, a storage unit 14, an input unit 15, a display unit 16, and a server communication unit 17. These units are interconnected with a bus 18. A car navigation device, a smartphone, a tablet terminal, and various other information processing devices can be used as the terminal device 4.

The processing unit 11 is formed, for instance, of a central processing unit (CPU) that can be driven with low power consumption. The processing unit 11 controls the operations of various units in the terminal device in accordance, for example, with programs and parameters read from the storage unit 14. In this instance, the processing unit 11 exercises control to issue operating instructions to various units in accordance with an operating signal inputted from the input unit 15, or to let the display unit 16 display, over a map, the current position information measured by the positioning unit 12.

Further, the processing unit 11 refers to a beacon position DB 9 stored in a storage device 8 of the server 7, which is accessed by the server communication unit 17 through the access point 5 and the network 6, acquires a beacon ID associated with the current position information, and sets, in accordance with the acquired beacon ID, the beacon ID to be acquired by the beacon signal receiver 13. Consequently, the beacon device 2 of which signal is to be received is limited in accordance with the beacon ID associated with the current position information acquired from the beacon position DB 9, and the beacon signal receiver 13 acquires only the beacon ID set as an acquisition target among beacon IDs included in received beacon signals.

Moreover, if the positioning unit 12 is unable to output the current position information obtained from the GPS signal, the processing unit 11 refers to the beacon position DB 9, acquires installation position information associated with the beacon ID acquired by the beacon signal receiver 13, and outputs the current position information determined from the beacon signal in accordance with the installation position information. The contents of the beacon position DB 9 and the details of processing performed by the processing unit 11 will be described later.

The positioning unit 12 receives a GPS signal from the GPS satellite 3 through an antenna (not shown), measures the current position of the terminal device 4, and outputs current position information. The positioning unit 12 may alternatively measure the current position of the terminal device 4 by using a signal received from the access point 5 or by using a combination of the GPS signal from the GPS satellite 3 and the signal received from the access point 5.

The beacon signal receiver 13 receives a beacon signal from the beacon device 2 through an antenna (not shown) and acquires a beacon ID included in the beacon signal.

The storage unit 14 is formed, for instance, of a storage medium used, for example, as a ROM (Read Only Memory) or RAM (Random Access Memory), and a memory card. The storage unit 14 permanently or temporarily stores various data, such as programs for controlling various units in the terminal device 4, parameters, and map data for a map displayed on the display unit 16.

The input unit 15 outputs an operating signal to the processing unit 11 in accordance with an operating instruction that is inputted by pressing a button or switch (not shown) disposed on the terminal device 4 or by touching a screen of the display unit 16.

The display unit 16 displays a map, which is formed, for instance, of text and an image, on a display surface. For the terminal device 4, the input unit 15 and the display unit 16 may be configured as a touch panel display in which an operating surface and the display surface are placed one on the other. When the positioning unit 12 outputs the current position information, the display unit 16 displays current position information over a map in accordance with the outputted current position information. However, when the positioning unit 12 is unable to output the current position information, the display unit 16 displays the current position information over a map in accordance with current position information derived from a beacon signal.

The server communication unit 17 is connected to the access point 5 through an antenna (not shown) and further connected from the access point 5 to the server 7 through the network 6. This enables the server communication unit 17 to access the beacon position DB 9 possessed by the server 7. It is assumed that the communication between the server communication unit 17 and the access point 5 is established in compliance with a communication standard such as a mobile communication standard (for example, 3G) or a wireless LAN (Local Area Network) standard (for example, Wi-Fi (registered trademark)).

The server 7 includes the storage device 8, which stores the beacon position DB 9. The storage device 8 is formed, for instance, of a large-capacity HDD (Hard Disk Drive).

The storage device 8 stores the beacon ID of the beacon device 2 and position information (installation position information) indicative of the installation position of the beacon device 2 in association with each other. In accordance with a request from the terminal device 4, the storage device 8 provides the beacon position DB 9 to the terminal device 4.

<Example of Beacon Device Installation>

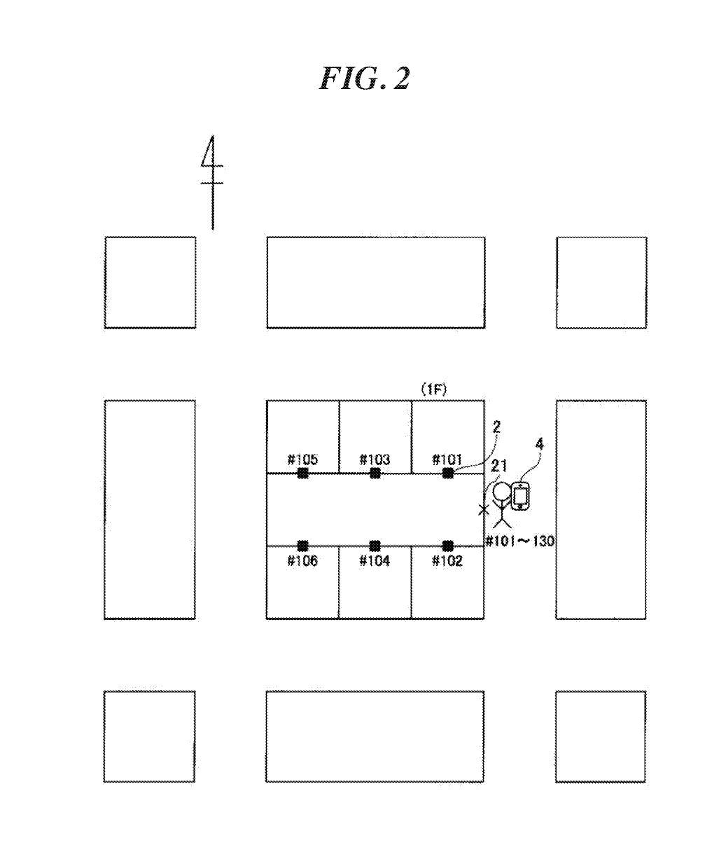

FIG. 2 illustrates an exemplary installation of a plurality of beacon devices 2. FIG. 2 illustrates a case where a user carrying the terminal device 4 is standing in front of an entrance of the department store “A” and the beacon devices 2 are installed for tenants on the first floor.

It is assumed that the department store “A” has five floors and houses a total of thirty tenants, six tenants per floor. It is also assumed that the tenants on all the floors are laid out in the same manner, and that three tenants are located on the north side and on the south side as indicated in FIG. 2.

The beacon device 2 is installed between each tenant and an aisle. A beacon ID is assigned to the beacon device 2 in order to uniquely identify a tenant. It is assumed that the following beacon IDs are assigned to the beacon devices 2 installed for the tenants on the individual floors.

First floor: Beacon IDs #101 to #106

Second floor: Beacon IDs #107 to #112

Third floor: Beacon IDs #113 to #118

Fourth floor: Beacon IDs #119 to #124

Fifth floor: Beacon IDs #125 to #130

<Exemplary Data Configurations of Beacon Position DB>

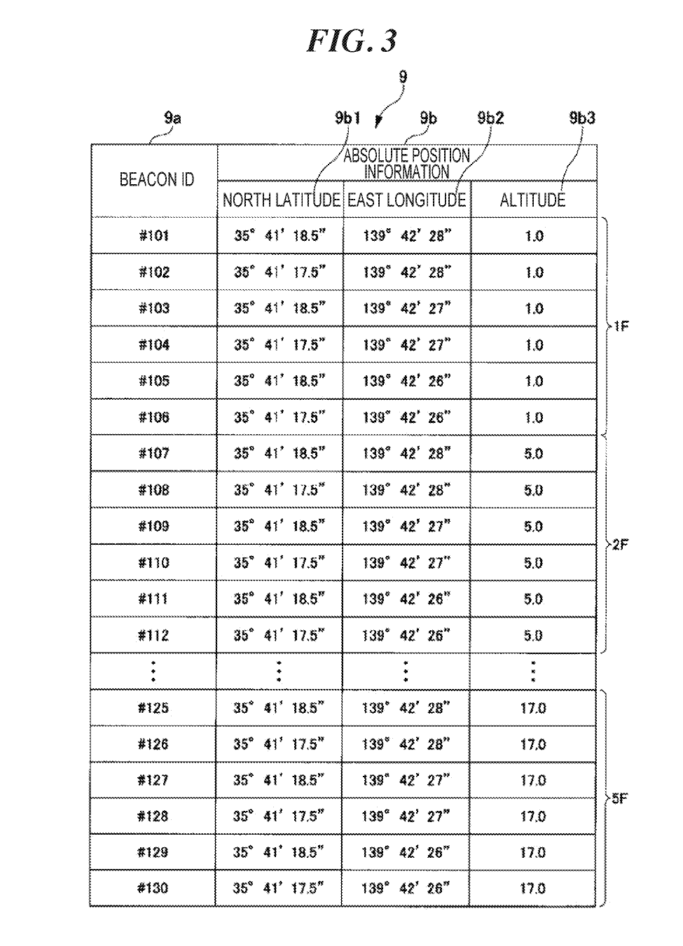

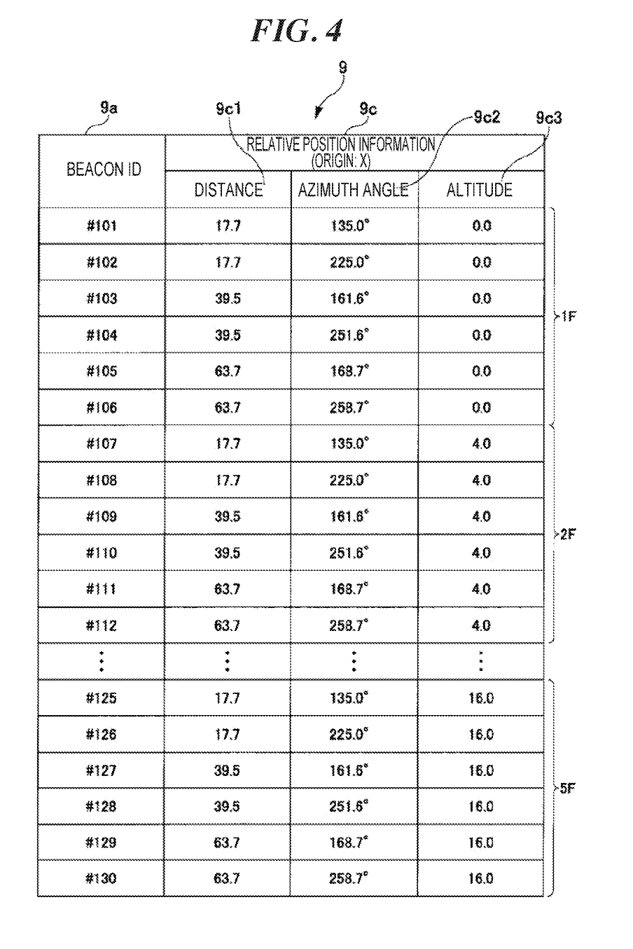

Exemplary data configurations of the beacon position DB 9 will now be described with reference to FIGS. 3 and 4.

(A. Exemplary Data Configuration of Beacon Position DB Including Absolute Position Information)

FIG. 3 illustrates an exemplary data configuration of the beacon position DB 9 including absolute position information.

The beacon position DB 9 includes a beacon ID field 9a and an absolute position information field 9b. FIG. 3 shows a part of the beacon position DB 9.

The beacon position DB 9 stores, in association with each other, the beacon ID assigned to each beacon device 2 and the installation position information of each beacon device 2. Absolute position information including latitude, longitude, and altitude (for example, geodetic height or altitude above sea level) is used as the installation position information. Thus, the absolute position information field 9b includes a north latitude field (latitude field) 9b1, an east longitude field (longitude field) 9b2, and an altitude field 9b3.

In the beacon position DB 9, for example, the position of a beacon device 2 that is positioned closest to the entrance of the department store “A” and assigned a beacon ID of “#101” is identified by absolute position information indicative of a north latitude of “35° 41′ 18.5″”, an east longitude of “139° 42′ 28″”, and an altitude of “1.0 m”. Therefore, when the beacon ID derived from a beacon signal received from the beacon device 2 is “#101”, the processing unit 11 can search the beacon ID field 9a of the beacon position DB 9 and acquire absolute position information associated with a beacon ID of “#101”. The processing unit 11 can then output the acquired absolute position information to the display unit 16 as the current position information.

Conversely, the processing unit 11 can acquire a beacon ID associated with current position information measured by the positioning unit 12. For example, current position information measured near the entrance of the department store “A” can be used to acquire the beacon ID of a beacon device 2 that is positioned in a predetermined area near the entrance or positioned closest to the entrance.

(B. Exemplary Data Configuration of Beacon Position DB Including Relative Position Information)

Further, when a predetermined position on a map is defined as the origin, the position of the beacon device 2 can be determined from the distance, azimuth angle, and altitude from the origin.

FIG. 4 illustrates an exemplary data configuration of the beacon position DB 9 including relative position information.

The beacon position DB 9 includes a beacon ID field 9a and a relative position information field 9c. FIG. 4 also shows a part of the beacon position DB 9.

The installation position information stored in the beacon position DB 9 represents the association between a beacon ID assigned to each beacon device 2 and the installation position information of a beacon device 2 that is uniquely identified with respect to the origin 21 set at the entrance of the department store “A”. Relative position information including the straight-line distance, azimuth angle, and altitude from the origin 21 is used as the installation position information. Thus, the relative position information field 9c includes a distance field 9c1, an azimuth angle field 9c2, and an altitude field 9c3.

In the beacon position DB 9, the position of a beacon device 2 whose beacon ID is “#101” is identified by relative position information (with respect to the origin 21) indicative of a distance of “17.7 m”, an azimuth angle of “135.0°”, and an altitude of “0.0 m”. Therefore, when the beacon ID derived from a beacon signal received from the beacon device 2 is “#101”, the processing unit 11 can search the beacon ID field 9a of the beacon position DB 9 and acquire relative position information associated with a beacon ID of “#101”. The processing unit 11 can then determine the absolute position information in accordance with the acquired relative position information and the position information of the origin 21, and output the determined absolute position information to the display unit 16 as the current position information. Conversely, the processing unit 11 can acquire a beacon ID associated with the current position information measured by the positioning unit 12.

Incidentally, in a building or other structure having a plurality of floors, such as the department store “A”, it is preferred that the beacon position DB 9 including the altitude field as indicated in FIGS. 3 and 4 be referred to.

<Exemplary Operation of Terminal Device>

An exemplary operation of the terminal device 4 will now be described.

In the department store “A”, the user can receive various information and services by using the terminal device 4 to receive a beacon signal from the beacon device 2 and acquire the beacon ID of the beacon device 2. When, for instance, the user enters the department store “A”, information about each tenant is distributed to the terminal device 4 and coupons available at various tenants are issued to the terminal device 4. Further, even if no GPS signal can be received in the department store “A”, the current position information of the user can be displayed over a map displayed on a display screen in accordance with the installation position information of an acquired beacon ID.

When the user enters a predefined area, the terminal device 4 communicates with the server 7 to acquire, from the beacon position DB 9, the beacon IDs of beacon devices 2 associated with the current position of the user. The following explanation assumes that the predefined area is an area near the entrance, for example, of a department store or a subway station. However, the predefined area may alternatively be set at various locations, for example, at regular intervals along a road. Another alternative is to achieve the intended purpose without setting such a predefined area, that is, periodically communicate with the server 7 and acquire, from the beacon position DB 9, the beacon IDs of beacon devices 2 associated with the current position of the user.

When, for instance, the user carrying the terminal device 4 comes close to the entrance of the department store “A” as indicated in FIG. 2, the current position information outputted from the positioning unit 12 enters a predefined area set near the entrance of the department store “A”. The processing unit 11 then refers to the beacon position DB 9 through the server communication unit 17 to acquire the beacon IDs of beacon devices 2 associated with the current position information. When, for instance, acquiring the beacon IDs of beacon devices 2 positioned within a horizontal radius of 100 m from the current position of the user, which is near the entrance of the department store “A”, the processing unit 11 acquires beacon IDs of #101 to #130 from the beacon position DB 9 through the server communication unit 17.

The processing unit 11 then sets the beacon IDs of #101 to #130, which are acquired from the beacon position DB 9, as the beacon IDs to be acquired by the beacon signal receiver 13. Thus, the processing unit 11 merely has to scan the beacon IDs of #101 to #130, which are selected as acquisition targets from beacon IDs included in a beacon signal received by the beacon signal receiver 13. This reduces the time required for beacon ID scanning.

When the user enters a predefined area set near the entrance of the department store “A”, the beacon signal reception system according to the first embodiment causes the processing unit 11 to perform setup so that only beacon IDs of #101 to #130, which are acquired from the beacon position DB 9 in accordance with the current position information, are handled as acquisition targets. The beacon signal receiver 13 then acquires only the beacon IDs of #101 to #130 among the beacon IDs included in the received beacon signal. This enables the processing unit 11 to acquire, for example, product information and coupon information about tenants for which beacon devices 2 with the acquired beacon IDs are installed. As described above, the processing unit 11 makes it possible to limit the beacon devices 2 of which signals are to be received, thereby reducing the time required for beacon ID scanning.

Further, at a place where the positioning unit 12 is unable to receive a GPS signal, the processing unit 11 can refer to the beacon position DB 9 through the server communication unit 17 and acquire the current position information associated with beacon IDs acquired by the beacon signal receiver 13. Consequently, current position information of the user can be seamlessly provided at a location inside and outside the department store “A” by using the current position information derived from a GPS signal or from a beacon signal.

<Example of Blocking an Illegal Beacon Signal>

Adverse effects produced by receiving illegal beacon signals can be avoided due to a secondary effect produced by limiting the beacon devices of which signals are to be received by the terminal device 4.

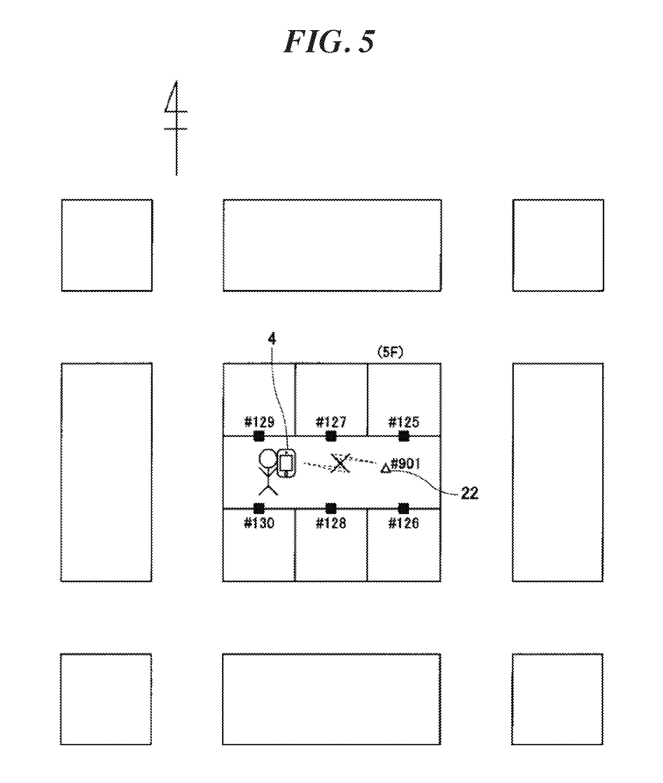

FIG. 5 illustrates an example in which the terminal device 4 blocks an illegal beacon signal.

In the example, a beacon device 22 on the fifth floor of the department store “A” transmits a beacon signal including a beacon ID other than the beacon IDs of #101 to #130, which are assigned to the tenants of the department store “A”. It is assumed that the beacon device 22 is not legitimately installed for a tenant and is adapted to transmit a beacon signal with a beacon ID of #901.

As mentioned earlier, the beacon IDs set as acquisition targets for the beacon signal receiver 13 range from #101 to #130, and the beacon ID of #901 is not set as an acquisition target. Therefore, even when the beacon signal receiver 13 receives a beacon signal from the beacon device 22, the beacon signal receiver 13 does not acquire the beacon ID of #901, which is included in the received beacon signal. This enables the terminal device 4 to block an illegal beacon signal.

### 1-2. First Modification of First Embodiment

<Exemplary Configuration of Beacon Signal Reception System>

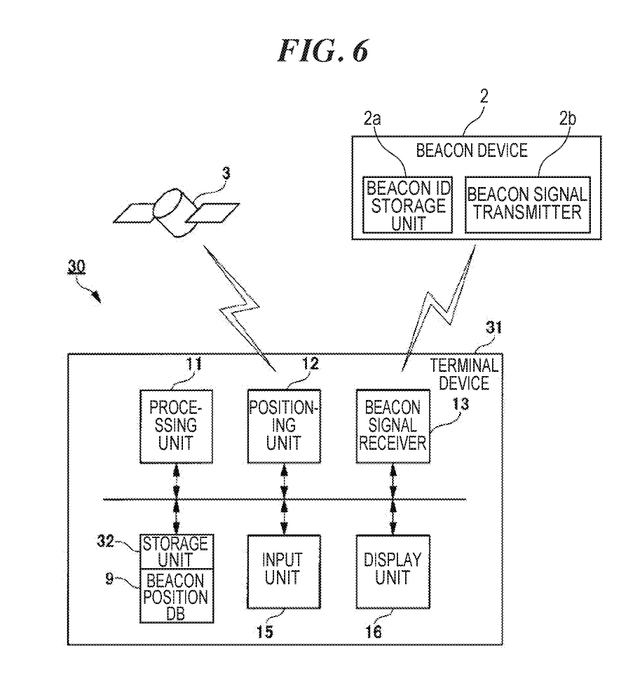

The beacon signal reception system according to a modification of the first embodiment of the present invention will now be described with reference to FIG. 6. The modification relates to a case where the current position information is provided based on the beacon position DB included in the terminal device.

FIG. 6 illustrates an exemplary configuration of a beacon signal reception system 30.

The beacon signal reception system 30 includes a terminal device 31, a beacon device 2, and a GPS satellite 3.

The terminal device 31 is basically similar to the terminal device 4 according to the first embodiment, but is different from the terminal device 4 in that the terminal device 31 does not include the server communication unit 17 and includes a storage unit 32 capable of storing the beacon position DB 9 as the storage unit. The storage unit 32, which is formed, for instance, of a large-capacity HDD, stores the beacon position DB 9 that covers various buildings.

In the terminal device 31 configured as described above, the processing unit 11 also refers to the beacon position DB 9 stored in the storage unit 32, acquires beacon IDs of beacon devices 2 associated with current position information outputted from the positioning unit 12, and sets beacon IDs to be acquired by the beacon signal receiver 13 in accordance with the acquired beacon IDs. As described above, the terminal device 31 is capable of limiting the beacon devices of which signals are to be received, without accessing the server 7, by storing, in advance, the beacon position DB 9 in the storage unit 32.

### 1-3. Second Modification of First Embodiment

<Exemplary Configuration of Beacon Position DB>

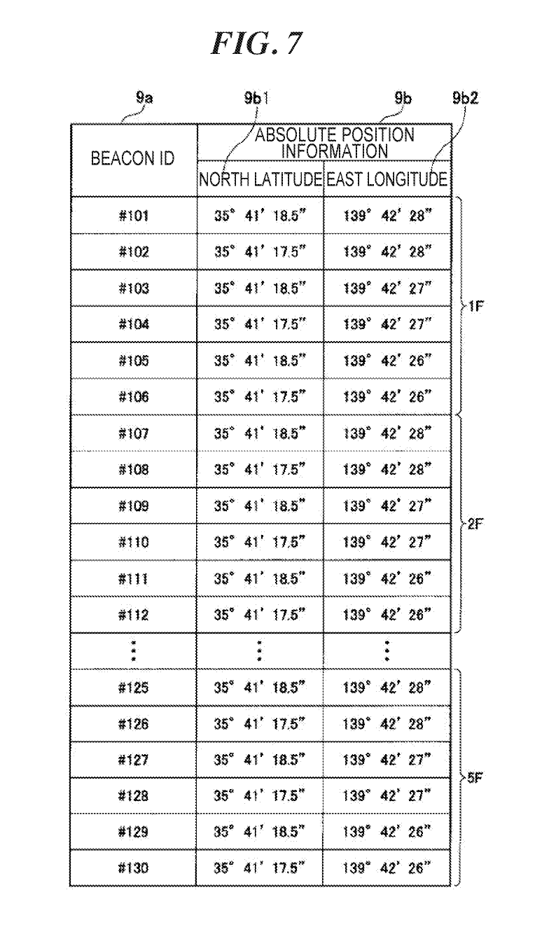

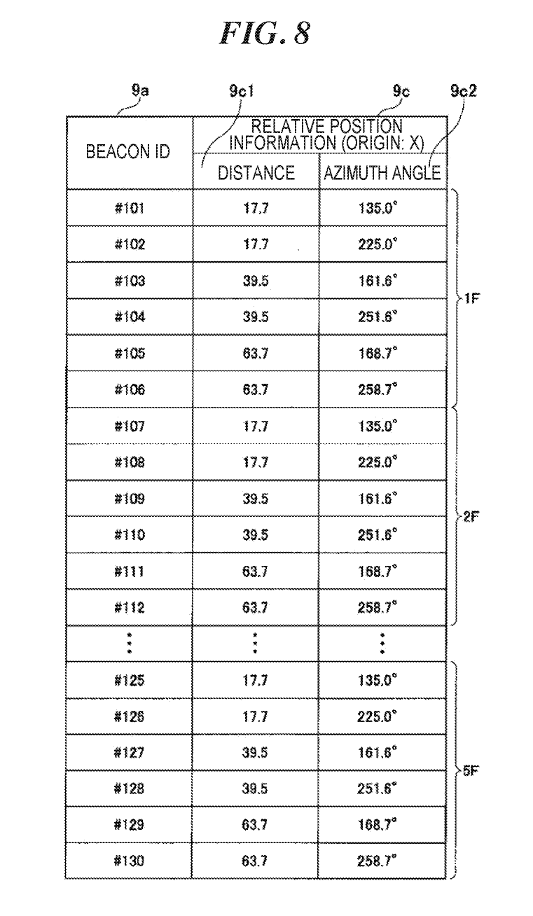

FIGS. 7 and 8 illustrate a modified configuration of the beacon position DB 9 as a second modification of the first embodiment.

FIGS. 3 and 4 illustrate an exemplary data configuration of the beacon position DB including absolute position information and relative position information, respectively. However, altitude information may be excluded when a target building does not have a plurality of floors.

FIG. 7 illustrates an exemplary data configuration of the beacon position DB 9 including absolute position information from which altitude information in FIG. 3 is eliminated.

FIG. 8 illustrates an exemplary data configuration of the beacon position DB 9 including relative position information from which altitude information in FIG. 4 is eliminated.

When the data configuration of the beacon position DB 9 is as indicated in FIG. 7 or 8, the amount of data included in the beacon position DB 9 can be reduced by the amount of altitude information.

When signals are to be received from the beacon devices 2 on all floors, the beacon position DB 9 shown in FIGS. 7 and 8, which does not include altitude information, may be used. However, if signals are to be received only from beacon devices 2 of tenants on the first floor of the department store “A”, it is necessary to select a target floor from the first to fifth floors. In such an instance, the beacon position DB 9 including the altitude information shown in FIGS. 3 and 4 is preferably used.

Further, if information about the relative position with respect to the origin 21 is stored in the beacon position DB 9 as indicated in FIGS. 4 and 8, the horizontal distance from the origin 21 need not be calculated. However, if the horizontal distance from a point other than the origin 21 is needed, the processing unit 11 converts the distance and azimuth angle derived from the beacon position DB 9 to latitude and longitude, and calculates the horizontal distance from the origin 21.

### 2. Second Embodiment

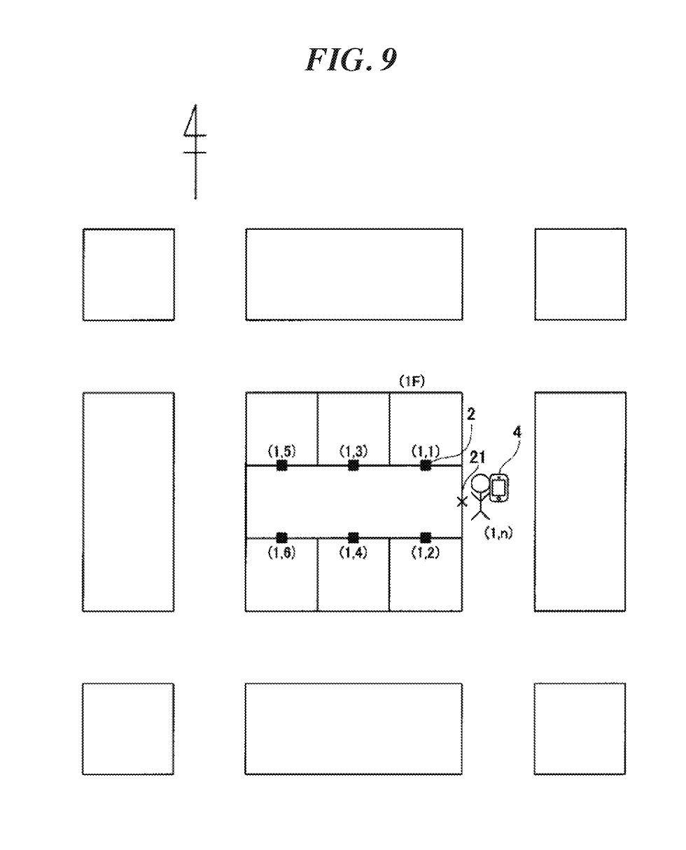

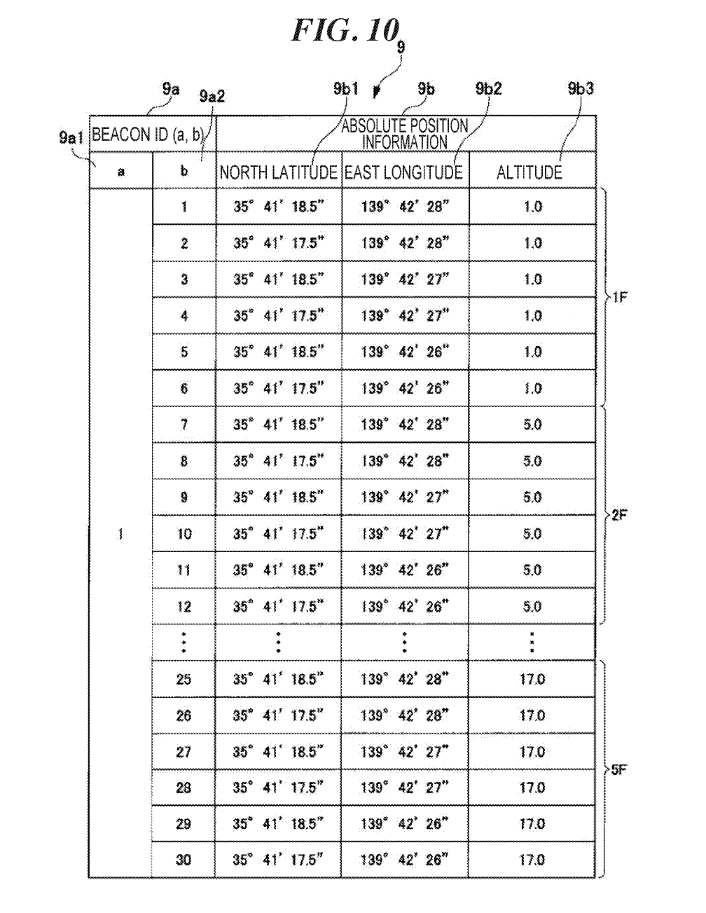

The beacon signal reception system according to a second embodiment of the present invention will now be described with reference to FIGS. 9 and 10.

FIG. 9 illustrates an exemplary installation of a plurality of beacon devices 2.

As is the case with FIG. 2, FIG. 9 also depicts a case where the beacon devices 2 are installed for tenants on the first floor of the five-storied department store “A”.

Beacon IDs assigned to the beacon devices 2 are in the form of (a, b). The first portion “a” identifies a department store, and the second portion “b”, which is a portion other than the first portion, identifies a tenant. The processing unit 11 sets the beacon IDs to be acquired by the beacon signal receiver 13 in accordance with “a”, which is the first portion of a beacon ID associated with the current position information.

If, for example, the beacon IDs are assigned to all the beacon devices 2 installed in the department store “A” so that “a”=“1”, the beacon IDs to be acquired by the beacon signal receiver 13 should be set as (1, n) (n is an arbitrary value). This permits the terminal device 4 to acquire the beacon IDs of the beacon devices 2 installed for the tenants on all floors of the department store “A”.

FIG. 10 illustrates an exemplary data configuration of the beacon position DB 9 including absolute position information.

The beacon position DB 9 includes the beacon ID field 9a and the absolute position information field 9b. FIG. 10 shows a part of the beacon position DB 9.

The beacon ID field 9a includes an “a” field 9a1 and a “b” field 9a2. The “a” field 9a1 stores the aforementioned first portion, and the “b” field 9a2 stores the aforementioned second portion. The “a” field 9a1 stores “1” for all the beacon devices 2. The “b” field 9a2 stores a value between “1” and “30” for each beacon devices 2.

For example, in accordance with the first portion stored in the “a” field 9a1, which relates to the beacon IDs that is associated with the current position information and is acquired from the beacon position DB 9, the terminal device 4 sets (1, n) (n is an arbitrary value) as the beacon IDs to be acquired by the beacon signal receiver 13. Subsequently, if the first portion “a” of a beacon ID derived from a beacon signal received from a beacon device 2 is “1”, the beacon signal receiver 13 acquires the beacon ID.

When the above-described beacon position DB 9 is used, all the beacon devices 2 installed in the department store “A” can be set, as a beacon device of which signal is to be received, without acquiring the beacon IDs of all the beacon devices 2 installed in the department store “A” from the beacon position DB 9. For example, the terminal device 4 acquires the beacon ID (1, 1) of a beacon device 2 installed for a northern tenant closest to the entrance of the department store “A” from the beacon position DB 9. This permits the processing unit 11 to set (1, n) as the beacon IDs to acquire, thereby handling all the beacon devices 2 in the department store “A” as a beacon device of which signal is to be received. In this instance, even if the department store “B” exists near the department store “A”, the beacon devices in the department store “B” can be set as a beacon device of which signal is not to be received as far as the beacon IDs are assigned to the beacon devices in the department store “B” in such a manner that “a”=“2”.

### 3. Third Embodiment

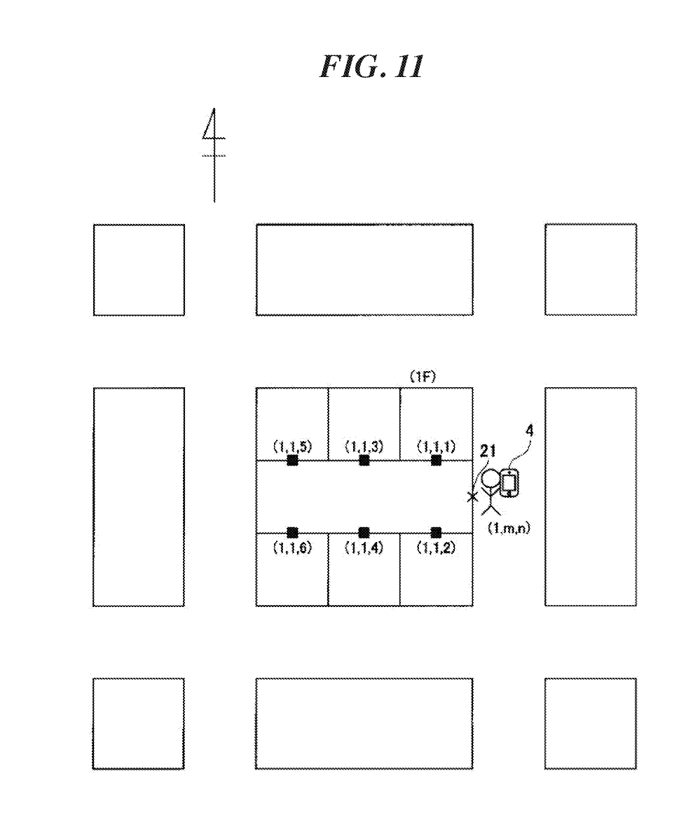

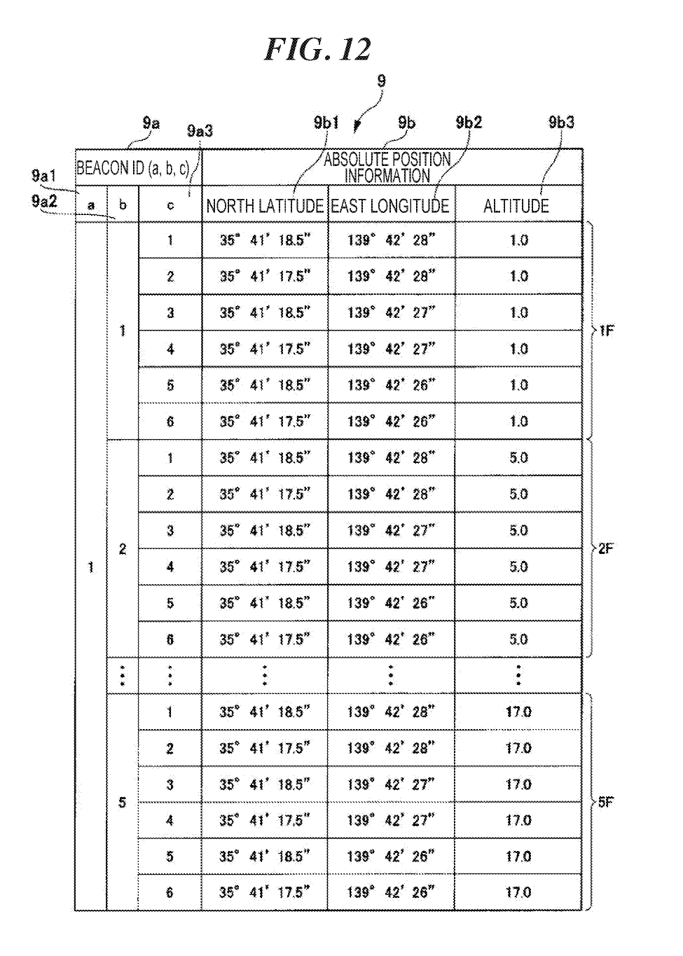

The beacon signal reception system according to a third embodiment of the present invention will now be described with reference to FIGS. 11 and 12.

FIG. 11 illustrates an exemplary installation of a plurality of beacon devices 2.

As is the case with FIG. 2, FIG. 11 also depicts a case where the beacon devices 2 are installed for tenants on the first floor of the five-storied department store “A”.

Beacon IDs assigned to the beacon devices 2 are in the form of (a, b, c). The first portion “a” identifies a department store, the second portion “b” identifies a floor, and the third portion “c” identifies a tenant. The processing unit 11 sets the beacon IDs to be acquired by the beacon signal receiver 13 in accordance with “a”, which is the first portion of a beacon ID associated with the current position information.

If, for example, the beacon IDs are assigned to all the beacon devices 2 installed in the department store “A” so that “a”=“1”, the beacon IDs to be acquired by the beacon signal receiver 13 should be set as (1, m, n) (m and n are arbitrary values). This permits the terminal device 4 to acquire the beacon IDs of the beacon devices 2 installed for the tenants on all floors of the department store “A”.

FIG. 12 illustrates an exemplary data configuration of the beacon position DB 9 including absolute position information.

The beacon position DB 9 includes the beacon ID field 9a and the absolute position information field 9b. FIG. 12 shows a part of the beacon position DB 9.

The beacon ID field 9a includes an “a” field 9a1, a “b” field 9a2, and a “c” field 9a3. The “a” field 9a1 stores the aforementioned first portion, the “b” field 9a2 stores the aforementioned second portion, and the “c” field 9a3 stores the aforementioned third portion. The “a” field 9a1 stores “1” for all the beacon devices 2. The “b” field 9a2 stores a value between “1” and “5” in accordance with the floor on which a beacon device 2 is installed. The “c” field 9a3 stores a value between “1” and “6” for six beacon devices 2 on each floor.

In the above instance, too, for example, in accordance with the first portion stored in the “a” field 9a1, which relates to the beacon IDs that is associated with the current position information and is acquired from the beacon position DB 9, the terminal device 4 sets (1, m, n) (m and n are arbitrary values) as the beacon IDs to be acquired by the beacon signal receiver 13. Subsequently, if the first portion “a” of a beacon ID derived from a beacon signal received from a beacon device 2 is “1”, the beacon signal receiver 13 acquires the beacon ID.

When the above-described beacon position DB 9 is used, only the beacon devices 2 on a particular floor can be set as a beacon device of which signal is to be received. If, for example, (1, 1, n) is set as the beacon IDs to be acquired, only the six beacon devices 2 on the first floor can be handled as a beacon device of which signal is to be received.

Further, the beacon position DB 9 may be configured in a manner not indicated in FIGS. 11 and 12 so that the first portion is in the form of “a+b” and that the second portion is in the form of “c”. Moreover, each beacon ID may be divided into four or more portions.

### 4. Fourth Embodiment

<Exemplary Use in a Subway>

The first to third embodiments have been described with reference to a case where the beacon devices 2 are installed for tenants in the department store “A”. However, the present invention is also applicable to other cases.

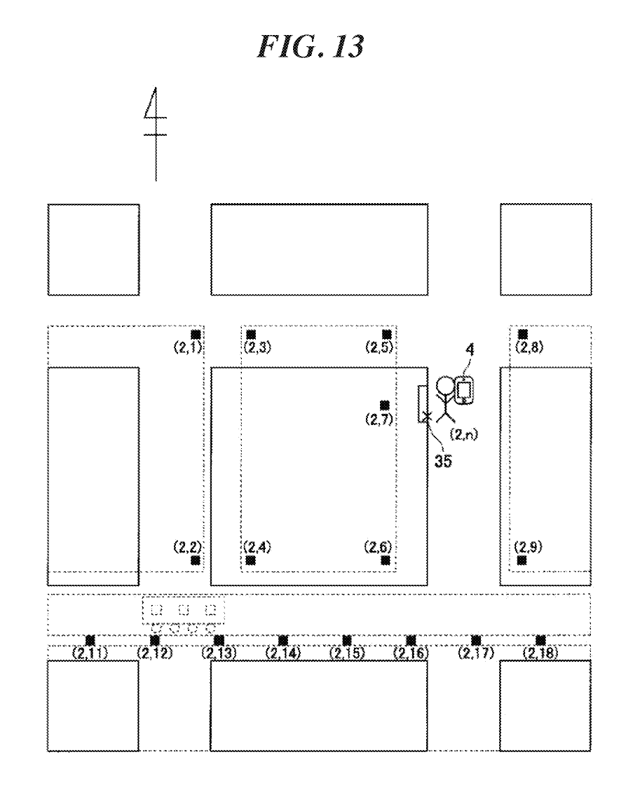

The beacon signal reception system according to a fourth embodiment of the present invention will now be described with reference to FIG. 13.

FIG. 13 illustrates an exemplary configuration of the beacon signal reception system. In FIG. 13, a floor plan of the subway station “Y”, which is drawn by broken lines, is displayed over an aboveground map drawn by solid lines.

Beacon devices 2 with beacon IDs of (2, 1) to (2, 9) are installed in the subway station “Y”, and beacon devices 2 with beacon IDs of (2, 11) to (2, 18) are installed along the railway track of a subway. A beacon device 2 with a beacon ID of (2, 7) is installed closest to an entrance among the beacon devices 2 installed in the subway station “Y”. Although not shown, it is assumed that beacon devices 2 with beacon IDs of (2, 19) to (2, 99) are additionally installed in a subway station other than the subway station “Y” and along the railway track of the subway.

When, for instance, a user carrying the terminal device 4 is about to enter the subway station “Y” through its entrance as indicated in FIG. 13, measured current position information enters a predefined area set near the entrance of the subway station “Y”. The terminal device 4 then refers to the beacon position DB 9 and acquires the beacon ID of a beacon device 2 associated with the current position information. For example, the terminal device 4 acquires, from the beacon position DB 9, the beacon ID (2, 7) of a beacon device 2 disposed closest to the entrance of the subway station “Y”. This permits the terminal device 4 to set (2, n) (n is an arbitrary value) as the beacon IDs targeted for acquisition, thereby handling all beacon devices 2 installed in the “Y” and other subway stations and along the railway track of the subway as a beacon device of which signal is to be received.

As is the case with the data in the beacon position DB 9 depicted in FIGS. 4 and 8, the data in the above-mentioned beacon position DB 9 may be configured to include relative position information of the beacon devices 2 relative to an origin 35, which is the entrance of the subway station “Y”.

### 5. Fifth Embodiment

<Exemplary Use in a Tunnel>

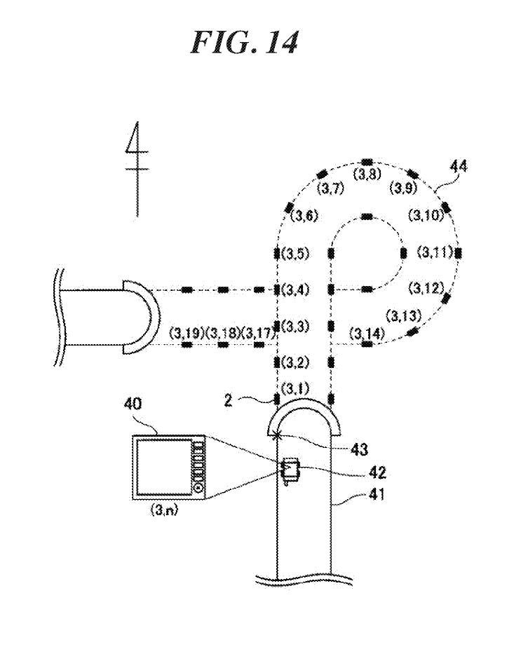

The beacon signal reception system according to a fifth embodiment of the present invention will now be described with reference to FIG. 14.

FIG. 14 illustrates an exemplary configuration of the beacon signal reception system. FIG. 14 depicts a road 41, a vehicle 42, and a tunnel 44.

The road 41 is shaped like a loop so as to permit a vehicle entering a south entrance to safely change its direction toward a west exit. The altitude of the road 41 gradually decreases along the road 41 so that the tunnel 44 has a grade separation. As an example of the terminal device, a car navigation device 40 is mounted in the vehicle 42. The display screen of the car navigation device 40 is enlarged in FIG. 14.

The beacon devices 2 are mounted on both side walls of the tunnel 44, from its entrance to its exit, in order to transmit a beacon signal to the car navigation device 40 within the tunnel 44 in which the GPS signal cannot be received. The beacon devices 2 mounted on the left side wall as viewed in the direction of travel are sequentially assigned beacon IDs of (3, 1) to (3, 19) from the entrance to the exit in order to uniquely identify the beacon devices 2.

For example, as indicated in FIG. 14, when the vehicle 42 approaches the entrance of the tunnel 44, the measured current position information enters a predefined area set near the entrance of the tunnel 44. The car navigation device 40 then refers to the beacon position DB 9 and acquires the beacon ID of a beacon device 2 associated with the current position information. For example, the car navigation device 40 acquires, from the beacon position DB 9, the beacon ID (3, 1) of a beacon device 2 installed closest to the entrance of the tunnel 44. This permits the car navigation device 40 to set (3, n) (n is an arbitrary value) as the beacon IDs targeted for acquisition, thereby handling all beacon devices 2 installed within the tunnel 44 as a beacon device of which signal is to be received. Then, as the vehicle 42 travels, the car navigation device 40 can successively receive a beacon signal from the beacon devices 2, refer to the beacon position DB 9, and acquire the current position information from an acquired beacon ID.

As is the case with the data in the beacon position DB 9 depicted in FIGS. 4 and 8, the data in the above-mentioned beacon position DB 9 may be configured to include relative position information of the beacon devices 2 relative to an origin 43, which is the entrance of the tunnel 44.

### 6. Modifications

In the above-described embodiments, it is assumed that a car navigation device, a smartphone, or a tablet terminal is used as the terminal device. However, for example, a feature phone, a pager, a portable music player, and a wristwatch may also be used as the terminal device.

Further, the beacon position DB 9 provides beacon IDs formed of serial numbers. Alternatively, however, the beacon position DB 9 may provide beacon IDs formed of alphanumeric characters.

Moreover, the present invention is not limited to the above-described embodiments. However, it is obvious that the present invention may have various other applications and modifications without departing from the spirit of the present invention that is defined in the appended claims.

For example, the foregoing embodiments have been described to explain about the detailed configurations of devices and system for the purpose of facilitating the understanding of the present invention. The present invention is not always limited to embodiments having all the described elements. Some elements of an embodiment may be replaced by the elements of another embodiment. Further, the elements of an embodiment may be added to the elements of another embodiment. Furthermore, some elements of each embodiment may be subjected to the addition of other elements, deleted, or replaced by other elements.

Moreover, indicated control lines and information lines are those that indicate what is considered necessary for explanation and are not intended to represent all the control lines and information lines required for a product. In fact, almost all elements may be considered connected to each other.

### REFERENCE SIGNS LIST

1 . . . Beacon signal reception system,

2 . . . Beacon device,

3 . . . GPS satellite,

4 . . . Terminal device,

7 . . . Server,

8 . . . Storage device,

9 . . . Beacon position database,

11 . . . Processing unit,

12 . . . Positioning unit,

13 . . . Beacon signal receiver,

14 . . . Storage unit,

15 . . . Input unit,

16 . . . Display unit,

17 . . . Server communication unit.

1. A beacon signal reception system comprising:
a server including a database adapted to store identification information and position information in association with each other, the identification information identifying a beacon device adapted to transmit a beacon signal, the position information indicating an installation position of the beacon device; and
a terminal device capable of communicating with the server,
the terminal device including
a server communication unit that is capable of communicating with the server and accessing the database,
a positioning unit adapted to measure a current position and output current position information,
a beacon signal receiver adapted to receive the beacon signal and acquire identification information of the beacon device included in the beacon signal, and
a processing unit adapted to refer to the database so as to acquire the identification information associated with the current position information and set, in accordance with the acquired identification information, the identification information to be acquired by the beacon signal receiver,
wherein the beacon signal receiver is adapted to acquire only the identification information set as an acquisition target by the processing unit among the identification information included in the received bacon signal.

2. The beacon signal reception system according to claim 1,
wherein the identification information of the beacon device includes a first portion and a second portion, the second portion being a portion other than the first portion, and
wherein the processing unit is adapted to set the identification information to be acquired by the beacon signal receiver in accordance with the first portion of the identification information associated with the current position information, and make the second portion of the identification information to be an arbitrary value.

3. A terminal device comprising:
a storage unit having a database adapted to store identification information and position information in association with each other, the identification information identifying a beacon device adapted to transmit a beacon signal, the position information indicating an installation position of the beacon device;
a positioning unit adapted to measure a current position and output current position information;
a beacon signal receiver adapted to receive the beacon signal and acquire identification information of the beacon device included in the beacon signal; and
a processing unit adapted to refer to the database so as to acquire the identification information associated with the current position information and set, in accordance with the acquired identification information, the identification information to be acquired by the beacon signal receiver,
wherein the beacon signal receiver is adapted to acquire only the identification information set as an acquisition target by the processing unit among the identification information included in the received beacon signal.

4. The terminal device according to claim 3,
wherein the identification information of the beacon device includes a first portion and a second portion, the second portion being a portion other than the first portion, and
wherein the processing unit is adapted to set the identification information to be acquired by the beacon signal receiver in accordance with the first portion of the identification information associated with the current position information, and make the second portion of the identification information to be an arbitrary value.

5. A beacon signal reception method comprising:
an output step of measuring a current position and outputting current position information;
a setting step of referring to a database so as to acquire identification information associated with the current position information and setting, in accordance with the acquired identification information, identification information to be acquired from a beacon signal, the database being adapted to store the identification information and position information in association with each other, the identification information identifying a beacon device adapted to transmit the beacon signal, the position information indicating an installation position of the beacon device; and
an acquiring step of receiving the beacon signal and acquiring only the identification information set as an acquisition target in the setting step among the identification information of the beacon device included in the beacon signal.

6. (canceled)
